(19) United States
(12) Patent Application Publication
(10) Pub. No.: US 2016/0344075 A1
(43) Pub. Date: Nov. 24, 2016

(54) Thermal Management System for a Vehicle

(71) Applicant: Ford Global Technologies, LLC, Dearborn, MI (US)

(72) Inventors: Timothy Noah BLATCHLEY, Dearborn, MI (US); Kenneth J. JACKSON, Dearborn, MI (US)

(21) Appl. No.: 14/717,405

(22) Filed: May 20, 2015

(51) Int. Cl. H01M 10/66; B60W 20/00; H01M 10/625

(52) U.S. Cl. CPC H01M 10/66; H01M 10/625; B60W 20/00; H01M 2220/20

(57) ABSTRACT

A vehicle includes a heat pump subsystem configured to circulate refrigerant through a condenser and an evaporator; and a coolant subsystem. The coolant system is configured to circulate coolant through a radiator, a powertrain component, a heater core, and a heat exchanger that is arranged to transfer heat from the refrigerant to the coolant. The coolant subsystem selectively transfers heat from the heat pump subsystem to the radiator to increase condensing capacity of the heat pump subsystem.

### TECHNICAL FIELD

The present disclosure relates to thermal management systems for motor vehicles and specifically to thermal management that includes a heat pump subsystem and a battery chiller.

### BACKGROUND

Vehicles such as battery-electric vehicles (BEVs), plug-in hybrid electric vehicles (PHEVs) and full hybrid-electric vehicles (FHEVs) contain a traction battery assembly to act as an energy source for the vehicle. The traction battery includes components and systems to assist in managing vehicle performance and operations. The traction battery also includes high voltage components. Some hybrid and electric vehicles are equipped with a climate control system that includes a heat pump subsystem for warming, cooling and/or dehumidifying a passenger cabin.

### SUMMARY

According to one embodiment, a vehicle includes a heat pump subsystem configured to circulate refrigerant through a condenser and an evaporator; and a coolant subsystem. The coolant system is configured to circulate coolant through a radiator, a powertrain component, a heater core, and a heat exchanger that is arranged to transfer heat from the refrigerant to the coolant. The coolant subsystem selectively transfers heat from the heat pump subsystem to the radiator to increase condensing capacity of the heat pump subsystem.

According to another embodiment, a vehicle includes a heat pump subsystem having refrigerant, and a chiller for cooling a battery. The vehicle also includes a coolant subsystem having a radiator, valves and a heat exchanger arranged to selectively transfer heat from the heat pump subsystem to the coolant subsystem. A controller is programmed to operate at least one of the valves such that heat from the heat pump subsystem is circulated to the radiator in response to the refrigerant actually, or predictively, exceeding a threshold pressure.

According to yet another embodiment, a vehicle includes a heat pump subsystem configured to circulate refrigerant through an interior heat exchanger, an exterior heat exchanger, and a battery chiller. The vehicle also includes a coolant subsystem configured to circulate coolant through a radiator, a powertrain component, a heater core, valving and a heat exchanger. wherein the heat exchanger is arranged to selectively transfer heat from the refrigerant to the coolant. A controller is programmed to operate the valving such that the radiator and the heat exchanger are thermally isolated in response to the vehicle being in a first operating mode, and is programmed to operate the valving such that the coolant circulates from the heat exchanger to the radiator allowing heat from the heat pump subsystem to be transferred to the radiator in response to the vehicle being in a second operating mode.

According to another embodiment, a vehicle includes a traction battery and a heat-pump subsystem having refrigerant and a chiller for cooling the battery. The vehicle also includes a coolant subsystem having a radiator, valves and a heat exchanger arranged to selectively transfer heat from the heat pump subsystem to the coolant subsystem. A charge port is provided on the vehicle and is electrically connected to the traction battery via circuitry. A controller is programmed to operate at least one of the valves such that heat from the heat pump subsystem is circulated to the radiator in response to current of the circuitry exceeding a threshold value.

### BRIEF DESCRIPTION OF THE DRAWINGS

FIG. 1 illustrates a schematic of a hybrid electric vehicle.

FIG. 2 illustrates a schematic of at least one thermal management system of the vehicle.

FIG. 3 illustrates a schematic of at least one thermal management system of the vehicle according to another embodiment.

FIG. 4 illustrates the thermal management system of FIG. 2 in a battery cooling mode according to a first routine.

FIG. 5 illustrates the thermal-management system of FIG. 2 in a battery cooling mode according to a second routine.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations. Used herein, a controller may refer to one or more controllers.

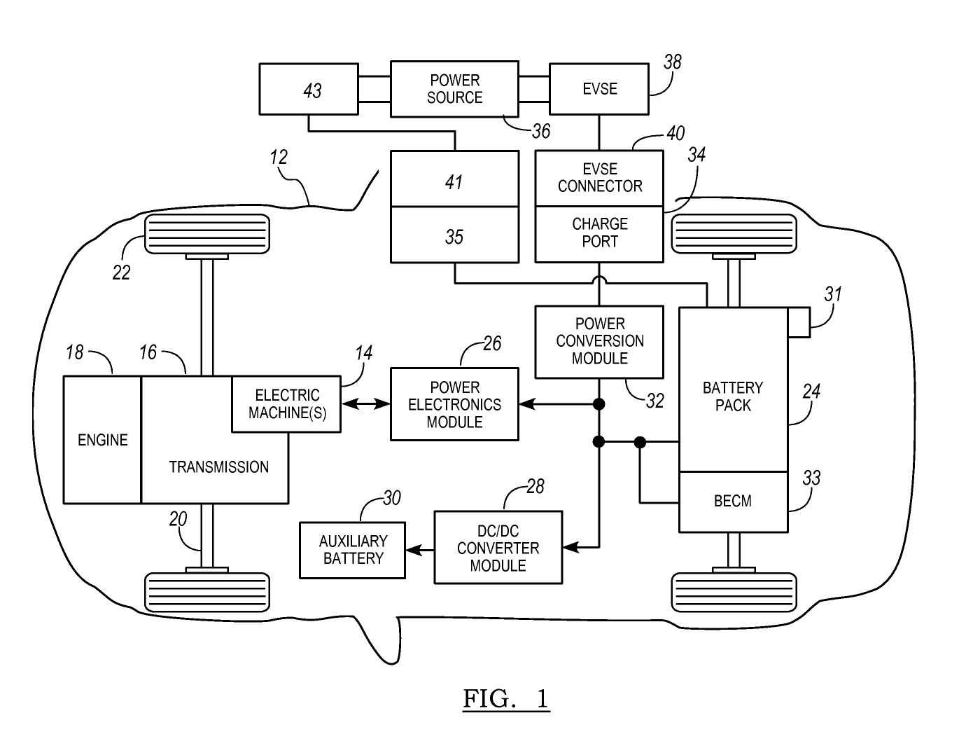

FIG. 1 depicts a schematic of an example plug-in hybrid-electric vehicle (PHEV). Certain embodiments, however, may also be implemented within the context of non-plug-in hybrids and fully-electric vehicles. The vehicle 12 includes one or more electric machines 14 mechanically connected to a hybrid transmission 16. The electric machines 14 may be capable of operating as a motor or a generator. In addition, the hybrid transmission 16 may be mechanically connected to an engine 18. The hybrid transmission 16 may also be mechanically connected to a drive shaft 20 that is mechanically connected to the wheels 22. The electric machines 14 can provide propulsion and deceleration capability when the engine 18 is turned on or off. The electric machines 14 also act as generators and can provide fuel economy benefits by recovering energy through regenerative braking. The electric machines 14 reduce pollutant emissions and increase fuel economy by reducing the work load of the engine 18.

A traction battery or battery pack 24 stores energy that can be used by the electric machines 14. The traction battery 24 typically provides a high voltage direct current (DC) output from one or more battery cell arrays, sometimes referred to as battery cell stacks, within the traction battery 24. The battery cell arrays may include one or more battery cells.

The traction battery 24 may be electrically connected to one or more power electronics modules 26 through one or more contactors (not shown). The one or more contactors isolate the traction battery 24 from other components when opened and connect the traction battery 24 to other components when closed. The power electronics module 26 may be electrically connected to the electric machines 14 and may provide the ability to bi-directionally transfer electrical energy between the traction battery 24 and the electric machines 14. For example, a typical traction battery 24 may provide a DC voltage while the electric machines 14 may require a three-phase alternating current (AC) voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the traction battery 24. The description herein is equally applicable to a fully-electric vehicle. In a fully-electric vehicle, the hybrid transmission 16 may be a gear box connected to an electric machine 14 and the engine 18 is not present.

In addition to providing energy for propulsion, the traction battery 24 may provide energy for other vehicle electrical systems. A typical system may include a DC/DC converter module 28 that converts the high voltage DC output of the traction battery 24 to a low voltage DC supply that is compatible with other vehicle components. Other high-voltage loads, such as compressors and electric heaters, may be connected directly to the high-voltage supply without the use of a DC/DC converter module 28. In a typical vehicle, the low-voltage systems are electrically connected to an auxiliary battery 30 (e.g., a 12 volt battery).

A battery energy control module (BECM) 33 may be in communication with the traction battery 24. The BECM 33 may act as a controller for the traction battery 24 and may also include an electronic monitoring system that manages temperature and charge state of each of the battery cells. The traction battery 24 may have a temperature sensor 31 such as a thermistor or other temperature gauge. The temperature sensor 31 may be in communication with the BECM 33 to provide temperature data regarding the traction battery 24.

The vehicle 12 may be recharged by an external power source 36. The external power source 36 may be an electric power grid. The external power source 36 is electrically connected to electric vehicle supply equipment (EVSE) 38. The EVSE 38 may provide circuitry and controls to regulate and manage the transfer of electrical energy between the power source 36 and the vehicle 12. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The EVSE connector 40 may have pins that mate with corresponding recesses of the charge port 34.

The vehicle 12 may have a plurality of different charging modes depending upon the type and power capacity of the EVSE 38. For example, the vehicle 12 may have a slow charging mode that is used when the EVSE 38 is a 110 volts power source. The vehicle 12 may have another charging mode that is used when the EVSE 38 is a 220 volts power source.

The vehicle 12 may have equipment configured for a fast charging mode. For example, the vehicle 12 may have fast-charge port 35 that is connectable with a fast-charge connector 41. The connector 41 may have a cord connected to a charging station 43. The charging station 43 may be a DC station that is configured to deliver high voltage and high current to the battery pack 24. For Example the charging station may deliver 400 plus volts. In one embodiment, the connector 41 may be the SAE J1772 Combo. The higher-voltage charging modes allow the vehicle to be charged faster because a higher amount of current is being supplied to the batteries 24. Because of the higher current, more heat is produced during the higher-voltage charging modes. In some of the charging modes, such as fast charge, the batteries must be actively cooled to prevent overheating.

The various components discussed may have one or more controllers to control and monitor the operation of the components. The controllers may communicate via a serial bus (e.g., Controller Area Network (CAN)) or via dedicated electrical conduits. The controller generally includes any number of microprocessors, ASICs, ICs, memory (e.g., FLASH, ROM, RAM, EPROM and/or EEPROM) and software code to co-act with one another to perform a series of operations. The controller also includes predetermined data, or “look up tables” that are based on calculations and test data, and are stored within the memory. The controller may communicate with other vehicle systems and controllers over one or more wired or wireless vehicle connections using common bus protocols (e.g., CAN and LIN). Used herein, a reference to “a controller” may refer to one or more controllers.

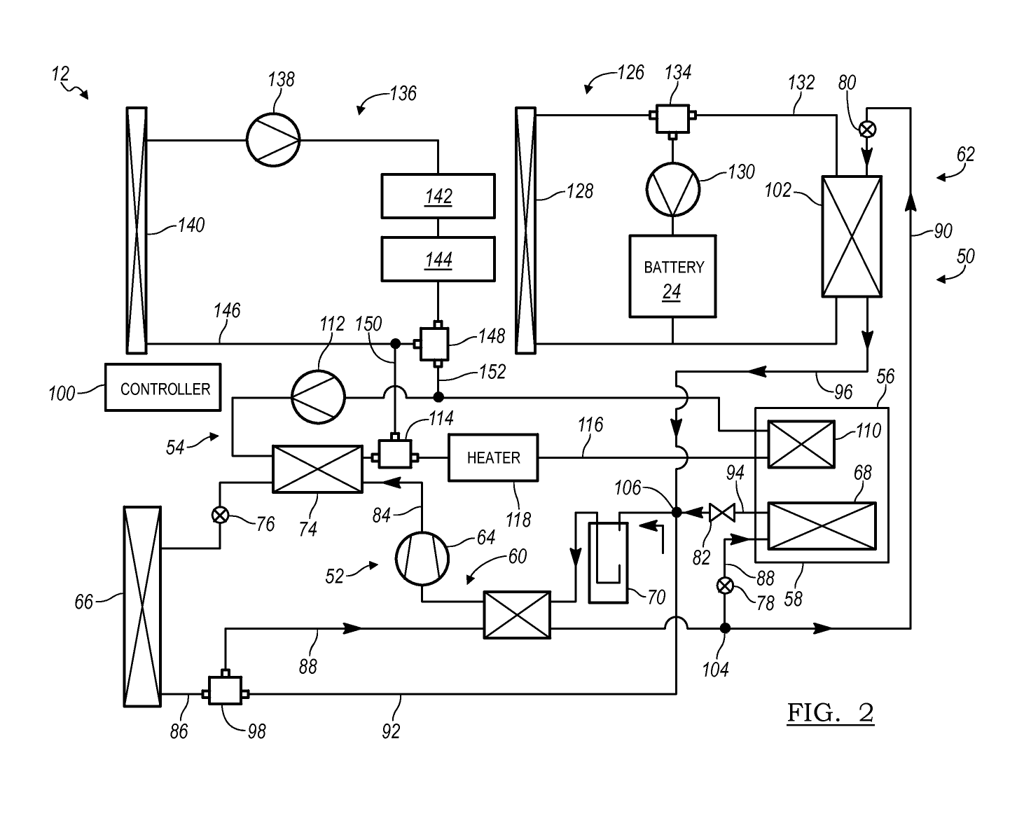

The traction battery 24 and other vehicle component are thermally regulated with one or more thermal management systems. Example thermal management systems are shown in the Figures and described below. Referring to FIG. 2, the vehicle 12 includes a cabin and an engine compartment that are separated by a bulkhead. Portions of the various thermal management systems may be located with the engine compartment and/or the cabin. The vehicle 12 includes a climate control system 50 having a heat pump subsystem 52, a heating subsystem 54, and a ventilation subsystem 56. The ventilation subsystem 56 may be disposed within the dash of the cabin. The ventilation subsystem 56 includes a housing 58 having an air intake side and air outlet side. The outlet side is connected to ducts that distribute exiting air into the cabin. A blower motor drives a fan for circulating air in the ventilation system 56.

The heat pump subsystem 52 may be a vapor-compression heat pump subsystem that circulates a refrigerant transferring thermal energy to various components of the climate control system 50. The heat pump subsystem 52 may include a cabin loop 60 having a compressor 64, an exterior heat exchanger 66 (e.g. condenser), an interior heat exchanger 68 (e.g. evaporator), an accumulator 70, fittings, valves and expansion devices. The condenser 66 may be located behind the grille near the front of the vehicle, and the evaporator 68 may be disposed within the housing 58. It is to be understood that heat exchangers labeled as “condenser” may also act as an evaporator in some modes, and heat exchangers labeled as “evaporator” may also act as a condenser in some modes.

The cabin loop components are connected in a closed loop by a plurality of conduits, tubes, hoses or lines. For Example, a first conduit 84 connects the compressor 64 and the condenser 66 in fluid communication, a second conduit 86 connects the condenser 66 to a valve 98, a third conduit 88 connects the valve 98 and the evaporator 68 in fluid communication, and a fourth conduit 94 connects the evaporator 68 and the compressor 64 in fluid communication. A first bypass conduit 92 is connected between the valve 98 and conduit 94. The valve 98 may be a solenoid valve that can be opened and closed to supply refrigerant to either the conduit 88 or conduit 92 depending upon the operating mode of the heat-pump subsystem 52. For example, refrigerant is circulated into conduit 88 and not into conduit 92 when the air conditioning is ON. The valve 98 may be in communication with a controller 100.

A first expansion device 76 may be disposed on conduit 84 and a second expansion device 78 may be disposed on conduit 88. The expansion devices are configured to change the pressure and temperature of the refrigerant in the heat-pump subsystem 52. The expansion devices may include an electronic actuator controlled by the controller 100. The controller 100 may instruct the actuator to position the expansion device in a wide-open position, a fully closed position, or a throttled position. The throttled position is a partially open position where the controller modulates the size of the valve opening to regulate flow through the expansion device. The controller 100 and expansion devices may be configured to continuously or periodically modulate the throttled position in response to system operating conditions. By throttling the position of the expansion device, the controller can regulate flow, pressure, temperature, and state of the refrigerant as needed.

The heat pump subsystem 52 also includes a battery loop 62 having a chiller 102 and a third expansion device 80. The battery loop 62 may include a supply conduit 90 connected to conduit 88 at fitting 104 and connected to the chiller 102. The expansion device 80 may be on the supply conduit 90. Expansion device 80 may be similar to expansion devices 76 and 78. A return conduit 96 connects the battery chiller 102 and conduit 94 in fluid communication. The return conduit 96 may connect with conduit 94 via fitting 106. A check valve 82 prevents refrigerant flowing from the battery chiller into the evaporator 68.

The heating subsystem 54 may include a heater core 110, a pump 112, a valve 114, a heater 118, and conduits 116 forming a closed loop for circulating coolant, such as an ethylene glycol mixture. In the case of a hybrid vehicle, the heating subsystem 54 is in fluid communication with an internal combustion engine (not shown). The heating subsystem 54 is configured to circulate heated coolant to the heater core during a heating mode of the climate control system 50. The coolant may be heated by extracting heat from the heat-pump subsystem 52, the heater 118, or an engine (if applicable). The heater core 110 is disposed within the ventilation system 56. One or more fans of the ventilation system circulate air over and through the heater core 110 to provide warm air into the cabin.

The heating subsystem 54 may extract heat from the heat-pump subsystem 52 via an intermediary heat exchanger 74 in order to provide heating to the cabin. The intermediary heat exchanger 74 may be a refrigerant-to-coolant heat exchanger. The intermediary heat exchanger 74 facilitates the transfer of thermal energy between the heating subsystem 54 and the heat pump subsystem 52. The intermediary heat exchanger 74 may be part of the heating subsystem 54, the heat pump subsystem 52, or both. The intermediary heat exchanger 74 may have any suitable configuration. For example, the intermediary heat exchanger 74 may have a plate-fin, tube-fin, or tube-and-shell configuration that facilitates the transfer of thermal energy without mixing the heat transfer fluids. The intermediary heat exchanger 74 may be connected to the first conduit 84 of the heat pump 52 and connected to one of the conduits 116 of the heating subsystem 54.

A battery cooling loop 126 regulates the temperature of the traction battery 24 and is in fluid communication with the chiller 102. The battery cooling loop 126 may include a radiator 128, a pump 130 and a plurality of conduits 132 that form a closed cooling loop for the traction battery 24. A fan (not shown) may be disposed adjacent to the radiator 128 and other heat exchangers to facilitate heat transfer between the air and the various heat exchangers on the vehicle. The fan may be disposed behind the grille of the vehicle. The conduits 132 include at least one valve 134 arranged to circulate coolant to the radiator 128 and/or the chiller 102 depending upon operating conditions. The battery coolant loop 126 may operate independently of the climate control system 50 and is capable of dissipating heat from the traction battery 24 via the radiator 128. The battery coolant loop 126 may also operate in cooperation with the climate control system 50 in order to dissipate heat utilizing the battery chiller 102. In most embodiments, the chiller has a higher cooling capacity than the radiator and is used during higher duty cycles. But, the radiator may be used alone for lower duty cycles, or when the ambient air temperature is cooler, such as in winter.

The battery chiller 102 facilitates the transfer of thermal energy between the heat pump subsystem 52 and the battery cooling loop 126. The battery chiller 102 may have any suitable configuration. For example, the chiller 102 may have a plate-fin, tube-fin, or tube-and-shell configuration that facilitates the transfer of thermal energy without mixing the heat transfer fluids in the battery coolant loop 126 and the heat-pump subsystem 52.

The vehicle 12 may include other cooling subsystems for various other heat generating components. For example, the vehicle 12 may include a powertrain cooling subsystem 136. Subsystem 136 may include a pump 138, a radiator 140, a first powertrain component 142 (e.g. a transaxle or transmission), a second powertrain component 144 (e.g. a power electronics component), and conduits 146 arranged to connect the system components in a closed cooling loop. The powertrain cooling subsystem 136 may circulate a coolant (e.g. ethylene glycol mixture).

The heating subsystem 54 may be in fluid communication with the powertrain-cooling subsystem 136. For example, a supply conduit 150 connects the valve 114 to the conduits 146 to selectively circulate coolant from the heating subsystem 54 to the powertrain cooling subsystem 136. The supply conduit 150 may be connected to the heating subsystem 54 at a location downstream of the heat exchanger 74 and connected to the powertrain cooling subsystem 136 at a location upstream of the radiator 140. A return conduit 152 connects a valve 148 to conduits 116 to selectively circulate coolant from the powertrain-cooling subsystem 136 to the heating subsystem 54. The return conduit 154 may be connected to the powertrain cooling subsystem 136 at a location downstream of the radiator 140 and connected to the heating subsystem 54 at a location upstream of the heat exchanger 74. The valves 114, 148 may be solenoid valves that are electrically controlled by the controller 100. The valves are actuatable to control circulation of coolant between the heating subsystem 54 and the powertrain cooling subsystem 136. For example, when the valves are in a first position, coolant within the heating subsystem 54 and the powertrain cooling subsystem 136 circulate independently of each other, and the radiator 140 and the heat exchanger 74 are thermally isolated from each other. When the valves are in the second position, coolant within the heating system 54 circulates into the powertrain cooling subsystem 136 such that thermal energy is transferred from the heat exchanger 74 to the radiator 140 for dissipation.

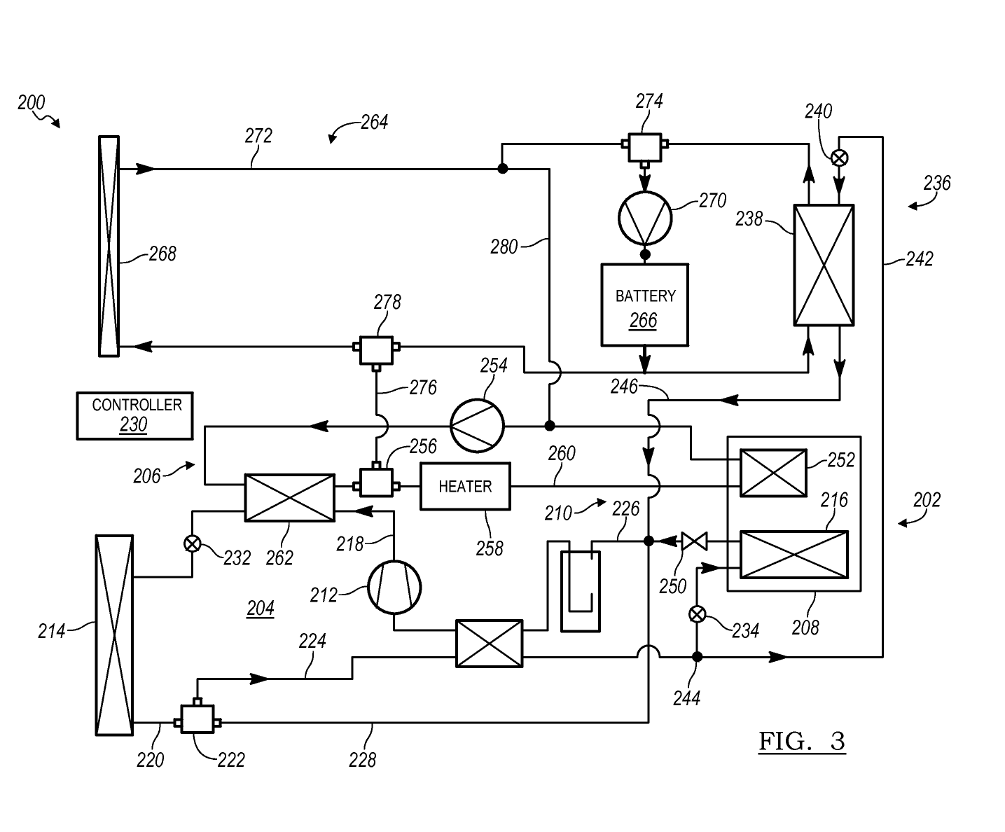

Referring to FIG. 3, a vehicle 200 includes a climate control system 202 having a heat pump subsystem 204, a heating subsystem 206, and a ventilation system 208. For brevity, some features that are similar to vehicle 12 will not be discussed again. The heat pump subsystem 204 may be a vapor compression heat-pump subsystem that circulates a refrigerant transferring thermal energy to various components of the climate control system 202. The heat pump subsystem 204 may include a cabin loop 210 having a compressor 212, an exterior heat exchanger 214 (e.g. condenser), an interior heat exchanger 216 (e.g. evaporator), an accumulator, fittings, valves and expansion devices. The cabin loop components are connected in a closed loop by a plurality of conduits, tubes, hoses or lines. For Example, a first conduit 218 connects the compressor 212 and the condenser 214 in fluid communication, a second conduit 220 connects the condenser 214 to a valve 222, a third conduit 224 connects the valve 222 and the evaporator 216 in fluid communication, and a fourth conduit 226 connects the evaporator 216 and the compressor 212 in fluid communication. A first bypass conduit 228 is connected between the valve 222 and conduit 226. The valve 222 may be a solenoid valve that can be opened and closed to supply refrigerant to either the conduit 224 or conduit 228 depending upon the operating mode of the heat pump subsystem 52. For example, refrigerant is circulated into conduit 224 and not into conduit 228 during when the air conditioning is ON. The valve 222 may be in communication with a controller 230.

A first expansion device 232 may be disposed on conduit 218 and a second expansion device 234 may be disposed on conduit 224. The expansion devices are configured to change the pressure and temperature of the refrigerant of the heat-pump subsystem 204. The expansion devices may include an electronic actuator that is controlled with the controller 230.

The heat-pump subsystem 204 also includes a battery loop 236 having a chiller 238 and a third expansion device 240. The battery loop 236 may include a supply conduit 242 that is connected to conduit 224 at fitting 244 and is connected to the chiller 238. The expansion device 240 may be on the supply conduit 242. A return conduit 246 connects the battery chiller 238 and conduit 226 in fluid communication. The return conduit 246 may connect with conduit 226 via fitting 248. A check valve 250 may be connected to conduit 226 to prevent refrigerant flowing from the battery chiller 238 into the evaporator 216.

The heating subsystem 206 may include a heater core 252, a pump 254, a valve 256, a heater 258, and conduits 260 forming a closed loop for circulating coolant. In the case of a hybrid vehicle, the heating subsystem 206 is in fluid communication with an internal combustion engine (not shown). The heating subsystem 206 is configured to circulate heated coolant to the heater core 252 during a heating mode of the climate control system 202. The heater core 252 is disposed within the ventilation system 208.

The heating subsystem 206 may extract heat from the heat-pump subsystem 204 via an intermediary heat exchanger 262 in order to provide heating to the cabin. The intermediary heat exchanger 262 may be a refrigerant to coolant heat exchanger. The intermediary heat exchanger 262 facilitates the transfer of thermal energy between the heating subsystem 206 and the heat-pump subsystem 204. The intermediary heat exchanger 262 may be connected to the first conduit 218 of the heat pump 204 and connected to one of the conduits 260 of the heating subsystem 206.

A battery cooling subsystem 264 regulates the temperature of the traction battery 266 and is in fluid communication with the chiller 238. The battery-cooling subsystem 264 may include a radiator 268, a pump 270 and a plurality of conduits 272 that form a closed cooling loop for the traction battery 266. The conduits 272 include at least one valve 274 arranged to circulate coolant to the radiator 268 and/or the chiller 238 depending upon operating conditions. The battery cooling subsystem 264 may be selectively connected to the heating subsystem 206 via conduits and valving such that heat may be selectively transferred from the heat-pump subsystem to the radiator 268 to increase condensing capacity of the heat-pump subsystem. A first interconnecting conduit 276 may connect between the valve 256 on the heat pump 204 and valve 278 on the battery cooling subsystem 264. A second interconnecting conduit 280 connects between one of the conduits 260 of the heat pump 204 and one of the conduits 272 of the battery cooling subsystem 264.

The various thermal management systems and climate control systems of vehicle may operate in a plurality of different operating modes. For example, the climate control system may operate in heating mode, air-conditioning mode, dehumidification mode, or OFF. Similarly, the thermal management systems may operate in a plurality of different cooling routines depending upon operating conditions of the various vehicle components that require cooling.

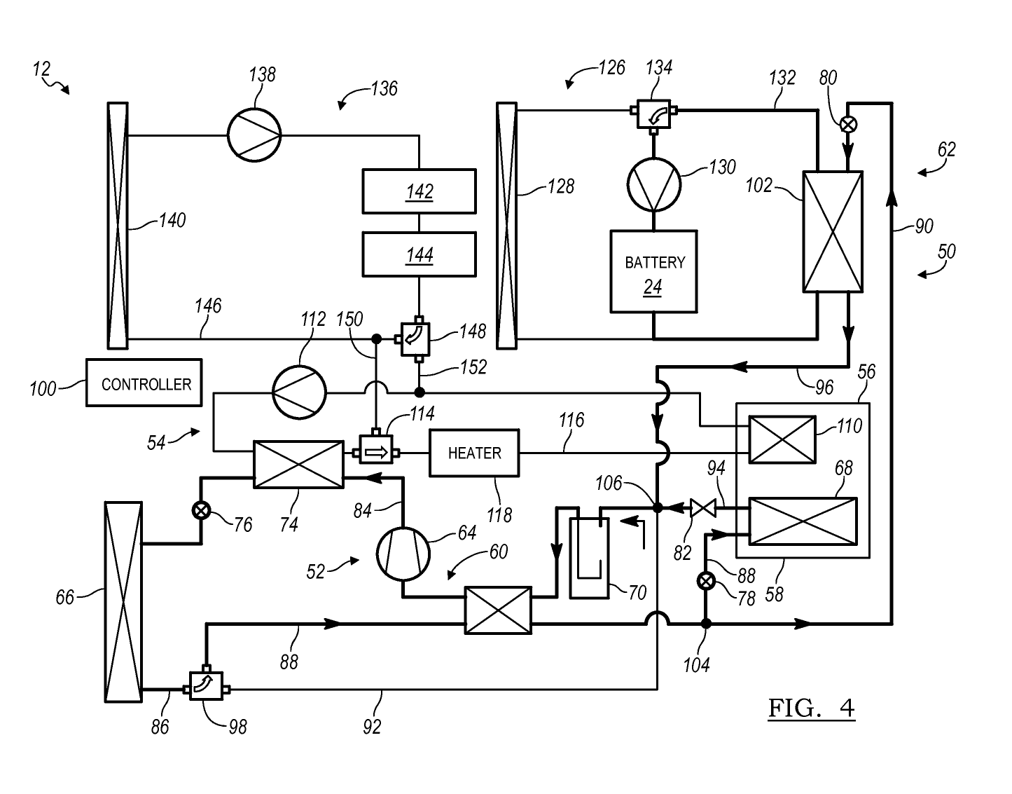

FIG. 4 illustrates the vehicle 12 with the heat pump subsystem 52 in one of many possible cooling routines. In this routine, the heating subsystem 54 is OFF and the powertrain cooling subsystem 136 is ON or OFF. The bold lines indicate conduits that are active during this routine. The battery cooling system 126 is cooled via the chiller 102, but the battery pack 24 may be cooled via the radiator 128 in other routines. The heat pump subsystem 52 is powered by a compressor 64 that pressurizes the refrigerant into a hot vapor. (Used herein, the terms hot, cold, high, or low are terms of relativeness and do not denote any specific temperature or pressure values.) The refrigerant exits the compressor 64 via conduit 84 and travels through the heat exchanger 74 (which is inactive) to the expansion device 76, which is in the wide-open position. The exterior heat exchanger 66 acts as a condenser and heat is transferred from the refrigerant to the outside air causing the refrigerant to condense into a substantially liquid state. The valve 98 is actuated such that the refrigerant flows from conduit 86 to the interior heat exchanger 68, which is acting as an evaporator, via conduit 88. In other cooling routines, the air conditioning may be OFF. In that case, expansion value 78 is closed and all refrigerant flows to the chiller. An auxiliary heat exchanger 72 may be disposed on conduit 88 to transfer some heat from the refrigerant in conduit 88 to the refrigerant in conduit 94. The auxiliary heat exchanger 72 is optional. Prior to entering the evaporator 68, the refrigerant circulates through expansion device 78, which is in the throttled position. The expansion device 78 lowers the pressure and temperature of the refrigerant prior to entering the evaporator 68. The evaporator 68 extracts heat from the air being circulated within the housing in order to cool the cabin. The refrigerant exits the evaporator 68 as a vapor and is circulated through the accumulator 70 and back to the compressor 64.

The expansion device 80 is in a throttled position, which places the battery loop 62 in an active state. A portion of the refrigerant flowing through conduit 88 is directed into conduit 90 via fitting 104. Prior to entering the chiller 102, the refrigerant passes through expansion device 80 which lowers the temperature and pressure of the refrigerant. The chiller 102 acts as an evaporator and the passing refrigerant boils and extracts heat from the battery cooling subsystem 126 as it passes through the chiller 102. The vaporized refrigerant is then circulated from the chiller 102 to conduit 94 via conduit 96 and joins with the refrigerant exiting the evaporator 68. While this cooling routine is described with reference to vehicle 12, it is equally applicable to vehicle 200, and other embodiments.

The heat pump subsystem 52 may experience heavy duty cycles when it is utilized to cool the traction battery and air-condition the cabin simultaneously. In order to properly function, the heat-pump subsystem must have adequate condensing capacity. During very heavy duty cycles, the condensing capacity of the heat pump subsystem 52 may be pushed to its limits, which can reduce the efficiency of the heat pump. These very heavy duty cycles may occur when the battery chiller and the A/C are operating simultaneously and it is hot outside; when the battery is producing a high amount of heat—such as during rapid charging or discharging; or when the condenser is damaged or malfunctioning.

The condensing capacity of the heat-pump system may be increased by increasing the size of the condenser. But, it may not be cost-effective to have a condenser that is oversized for most of the heat pump duty cycle. A more cost-efficient solution may be to enlist other radiators already on the vehicle during times of need. For example, the battery radiator (or other radiators) may be used as a secondary condenser during heavy duty cycles of the heat pump. In order to accomplish this, the various thermal management systems must be in thermal communication with the heat pump subsystem 52. FIGS. 2 and 3 illustrate two example vehicles having this capability. In FIG. 2, the radiator 140 can be selectively used as a secondary condenser, and in FIG. 3 the battery radiator 128 can be selectively used as a secondary condenser.

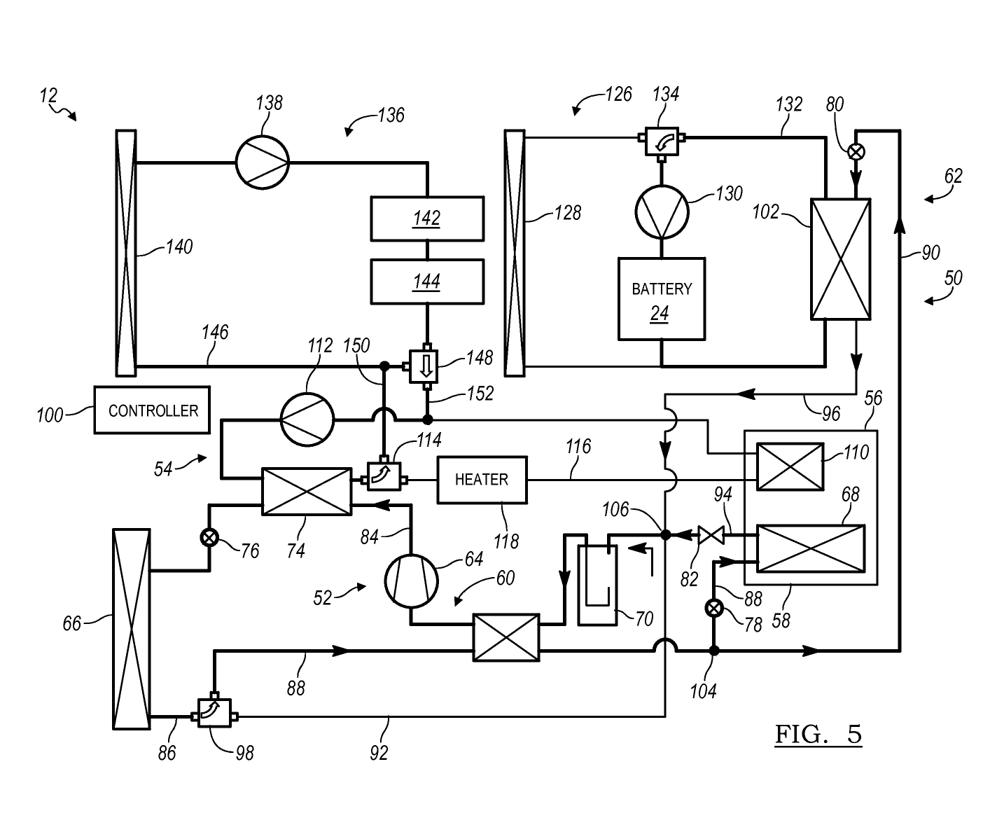

Referring to FIG. 5, the vehicle 12 is illustrated during a heavy duty cycle. Here, the main radiator 140 is being used as an additional condenser to increase the condensing capacity of the heat pump subsystem 52. In this routine, a portion of the heating subsystem 54 is ON and the valves 114 and 148 are actuated by the controller 100 such that the heating subsystem 54 and the powertrain cooling subsystem 136 are in fluid communication and act as a single thermal circuit. The cabin cooling can be active or inactive during this routine.

The compressor 64 circulates hot vaporized refrigerant through the heat exchanger 74 causing some of the heat within the refrigerant to be transferred into the coolant of the heating subsystem 54. This reduces the workload on the condenser 66 and increases the condensing capacity of the heat pump. The pump 112 circulates the heated coolant from the heat exchanger 74 to the radiator 140 via conduits 116, 150 and 146. The pump 138 may act as a booster pump to recirculate the coolant back to the heating subsystem 54 via conduit 152. In some embodiments, the pump 138 may be inactive.

The vehicle 200 is also capable of circulating thermal energy from the heat-pump subsystem 204 to the battery radiator 268 to increase condensing capacity. Similar to vehicle 12, heat is transferred from the heat pump 204 to the heating subsystem 206 via the heat exchanger 262. The heating subsystem 206 is connected to the battery cooling subsystem 264 via conduits 276 and 280 forming a single thermal circuit allowing the heated coolant to circulate from the heat exchanger 262 to the battery radiator 268. In this routine, the valve 274 may be actuated such that coolant is circulated through the battery 266 to the chiller 238 and not to the battery radiator 268. The valve 278 is actuated such that coolant circulating from the heat exchanger 262 via conduit 276 flows to the battery radiator 268 and not to the battery pack 266 or the chiller 238.

One or more controllers, such as controller 100, are programmed to actuate the valves, pumps, expansion devices, and other components to switch between the various operating modes. The controller may be in electrical communication with a plurality of sensors that provide inputs for the controller. The controller uses these inputs to determine when and how the valves should be actuated. The inputs may be directly sensed by sensors or may be inferred or calculated based on other measured values. In one example, the controller 100 is programmed to actuate select components to switch the heat pump into an increased-condensing mode, which is shown in FIG. 5. The controller 100 may do this in response to the pressure within the heat pump subsystem exceeding a threshold value. In some embodiments, the controller may be able to predict an expected pressure value and switch to the increased-condensing mode prior to the pressure actually reaching the threshold value. In at least one embodiment, the controller may switch to increased-condensing mode based on the pressure within the heat-pump subsystem and the ambient air temperature.

In an alternative embodiment, the controller 100 may be programmed to switch to an increased-condensing mode based on a charging rate of the battery. For example, the controller may monitor current flowing though circuitry connecting the charging port to the battery to determine the charging rate. In at least one embodiment, the controller may switch to increased-condensing mode based on charging rate of the battery and the ambient air temperature.

In other embodiments, the controller may switch the heat pump to increased-condensing mode in response to the vehicle being in a certain operating mode rather than basing the decision on a pressure, temperature or charge rate input. The controller may be programmed to do this for operating conditions that are likely to require the increased condensing capacity. For example, the controller operates the valves such that the radiator and the intermediary heat exchanger are thermally isolated in response to the vehicle being in a first operation mode, which has a low or zero probability of surpassing the condensing capacity of the condenser. A change in vehicle operating conditions may cause the controller to operate the valving such that the coolant circulates from the intermediate heat exchanger to the radiator (e.g. radiator 128 or radiator 140) allowing heat from the heat pump to be transferred to the radiator in response to the vehicle being in a second operating mode.

The controller may be programmed to actuate the valves such that the vehicle is in increased-condensing mode in response to the vehicle being in a battery-charging mode. For example, the controller may predict that the pressure limits of the heat pump will be exceeded during fast-charge mode and may preventively actuate the valves to increased-condensing mode.

Referring back to FIG. 2, the climate control system 50 may be operated in heating mode. In heating mode, the compressor 64 pressurizes the refrigerant into a hot vapor that is circulated to the heat exchanger 74. The thermal energy from the refrigerant is transferred into the coolant circulating through the coolant side of the heat exchanger 74 to heat the coolant in the heating subsystem 54. The pump 112 circulates the heated coolant to the heater core 110 to warm the cabin. The heat exchanger 74 acts as a condenser causing the refrigerant to condense into a liquid. Next, the refrigerant passes through the first expansion device 76, which is in a throttled position. The expansion device 76 reduces the pressure of the refrigerant and lowers the temperature of the refrigerant prior to entering the exterior heat exchanger 66. The controller 100 may throttle the expansion device 76 to ensure that the temperature of the refrigerant is below the outside air temperature to facilitate evaporation of the refrigerant within the exterior heat exchanger 66. Expansion device 78 is closed and valve 98 is positioned to cause refrigerant exiting the exterior heat exchanger 66 to flow through conduit 92 bypassing the interior heat exchanger 68. The refrigerant is then circulated through conduit 94 and back to the compressor 64 for recirculation.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a heat pump subsystem configured to circulate refrigerant through a condenser and an evaporator; and
a coolant subsystem configured to circulate coolant through a radiator, a powertrain component, a heater core, and a heat exchanger that is arranged to transfer heat from the refrigerant to the coolant, wherein the coolant subsystem selectively transfers heat from the heat pump subsystem to the radiator to increase condensing capacity of the heat pump subsystem.

2. The vehicle of claim 1 wherein the powertrain component is a traction battery assembly and the heat pump subsystem is further configured to circulate refrigerant through a battery chiller.

3. The vehicle of claim 2 wherein the coolant subsystem further includes a valve disposed on a conduit connecting between the radiator and the heat exchanger, and wherein the valve is configured to allow the coolant to circulate from the heat exchanger to the radiator when in a first position, and to prevent the coolant from circulating from the heat exchanger to the radiator when in a second position.

4. The vehicle of claim 2 wherein the coolant subsystem further includes a battery cooling loop in fluid communication with the radiator, the traction battery assembly and the battery chiller, and a heating loop in fluid communication with the heater core and the heat exchanger, wherein an interconnecting conduit is connected to the heating loop at a location downstream of the heat exchanger and is connected to the battery cooling loop upstream of the radiator.

5. The vehicle of claim 4 wherein the interconnecting conduit further includes at least one valve for selectively connecting the battery cooling loop and the heating loop in fluid communication.

6. The vehicle of claim 1 wherein the powertrain component is a transaxle or a power electronics module.

7. The vehicle of claim 6 further comprising a battery coolant subsystem configured to circulate coolant through a traction-battery assembly, a battery radiator and a chiller, wherein the coolant in the battery coolant subsystem is isolated from the coolant in the coolant subsystem.

8. The vehicle of claim 6 wherein the coolant subsystem further includes a powertrain cooling loop in fluid communication with the radiator and the powertrain component, and a heating loop in fluid communication with the heater core and the heat exchanger, wherein an interconnecting conduit is connected to the heating loop at a location downstream of the heat exchanger and is connected to the powertrain cooling loop upstream of the radiator.

9. A vehicle comprising:
a heat pump subsystem including refrigerant and a chiller for cooling a battery;
a coolant subsystem including a radiator, valves and a heat exchanger arranged to selectively transfer heat from the heat pump subsystem to the coolant subsystem; and
a controller programmed to operate at least one of the valves such that heat from the heat pump subsystem is circulated to the radiator in response to the refrigerant actually, or predictively, exceeding a threshold pressure.

10. The vehicle of claim 9 wherein the coolant subsystem is in fluid communication with the chiller and further includes a traction battery assembly.

11. The vehicle of claim 10 wherein the heat pump subsystem further includes a condenser, and is arranged to dissipate heat via the condenser and the radiator simultaneously.

12. The vehicle of claim 9 wherein the coolant subsystem further includes a conduit connecting between the radiator and the heat exchanger, and wherein at least one of the valves is disposed on the conduit and arranged to allow the coolant to circulate from the heat exchanger to the radiator when in a first position and to thermally isolate the radiator and the heat exchanger when in a second position.

13. The vehicle of claim 12 wherein the controller commands the valve on the conduit to the first position in response to the refrigerant actually, or predictively, exceeding a threshold pressure.

14. The vehicle of claim 9 wherein the coolant subsystem further includes a battery cooling loop in fluid communication with the radiator, a traction battery assembly and the chiller, and a heating loop in fluid communication with a heater core and the heat exchanger, wherein an interconnecting conduit is connected to the heating loop at a location downstream of the heat exchanger and is connected to the battery cooling loop upstream of the radiator.

15. A vehicle comprising:
a heat pump subsystem configured to circulate refrigerant through an interior heat exchanger, an exterior heat exchanger, and a battery chiller;
a coolant subsystem configured to circulate coolant through a radiator, a powertrain component, a heater core, valving and a heat exchanger, wherein the heat exchanger is arranged to selectively transfer heat from the refrigerant to the coolant; and
a controller programmed to operate the valving such that the radiator and the heat exchanger are thermally isolated in response to the vehicle being in a first operating mode, and programmed to operate the valving such that the coolant circulates from the heat exchanger to the radiator allowing heat from the heat pump subsystem to be transferred to the radiator in response to the vehicle being in a second operating mode.

16. The vehicle of claim 15 wherein the first operating mode is a non-battery charging mode and the second operating mode is a battery charging mode.

17. The vehicle of claim 16 wherein the battery charging mode is a fast-charging mode.

18. The vehicle of claim 15 wherein the powertrain component is a traction battery assembly.

19. The vehicle of claim 18 further including a charge connector electrically connected to the traction battery assembly and configured to mechanically connect with an external charge port, wherein the charge connector is mechanically coupled to the external charge port when the vehicle is in the second operating mode.

20. A vehicle comprising:
a traction battery;
a heat-pump subsystem including refrigerant and a chiller for cooling the battery;
a coolant subsystem including a radiator, valves and a heat exchanger arranged to selectively transfer heat from the heat pump subsystem to the coolant subsystem;
a charge port electrically connected to the traction battery via circuitry; and
a controller programmed to operate at least one of the valves such that heat from the heat pump subsystem is circulated to the radiator in response to current of the circuitry exceeding a threshold value.
